(19) United States
(12) Patent Application Publication
(10) Pub. No.: US 2019/0054461 A1
(43) Pub. Date: Feb. 21, 2019

(54) MULTI-USE COMBINED MICRO AND NANOWELL PLATES

(71) Applicant: UNIVERSITY OF HOUSTON SYSTEM, Houston, TX (US)

(72) Inventor: Navin Varadarajan, Houston, TX (US)

(73) Assignee: UNIVERSITY OF HOUSTON SYSTEM, Houston, TX (US)

(21) Appl. No.: 15/764,014

(22) PCT Filed: Sep. 30, 2016
(86) PCT No.: PCT/US16/54737

§ 371 Date: Mar. 28, 2018

Related U.S. Application Data
(60) Provisional application No. 62/234,789, filed on Sep. 30, 2015.

(51) Int. Cl. B01L 3/00

(52) U.S. Cl. CPC B01L 3/5085; B01L 2200/12; B01L 2300/0829; B01L 2300/0896; B01L 2300/0832; B01L 2300/0893; B01L 2200/025; B01L 2300/0809; B01L 2300/0887

(57) ABSTRACT

A multi-use combined micro and nanowell plate may provide nanowell arrays within the individual microwells of the plate. One or more microwells of the plate may provide an array of nanowells disposed at the bottom of the microwell. The combined micro and nanowell plate may be formed from a top frame with voids defining the microwells, and a bottom plate with voids defining the array of nanowells. When the top frame and the bottom plate are joined, the nanowell arrays may be aligned with the microwells to provide a combined micro/nanowell.

### RELATED APPLICATIONS

This application claims the benefit of U.S. Provisional Patent Application No. 62/234,789 filed on Sep. 30, 2015, which is incorporated herein by reference.

### FIELD OF THE INVENTION

This invention relates to multi-use combined micro and nanowell plates.

### BACKGROUND OF INVENTION

A multi-well plate is a fixed dimension container harboring multiple (e.g. 96-1536) “wells” that act as individual chambers or reservoirs facilitating individual assays to be experimented in parallel. The plate dimensions are specified by the Society for Biomolecular Screening. Plates may maintain a 127.76×85.47 mm footprint regardless of the number of wells, and the number and spacing of the wells has been standardized around the 96-well plate, which has 8×12 wells spaced 9 mm center-to-center. This standardization of plate geometry in turn allows for interfacing with other instruments like liquid handing robots, plate scanners, or the like. Higher density plates, like 384 or 1536 plates, aim to preserve the overall footprint, but reduce the well-to-well spacing enabling more assays to be run in parallel on the same plate. Other plates based on such a pattern may increase the well density by an integer factor of the 8×12 arrangement. The availability of plurality of wells on a single plate enables the routine screening of multiple chemical compounds against the same cell lines or type and prioritization of lead compounds that display the desirable phenotypic effect.

The number of wells per plate continues to grow since more wells per plate mean fewer plates used. This is important in operations like high-throughput testing where hundreds of thousands of experiments are routinely executed in a day. Industry standards set by the Microplate Standards Development Committee of the Society of Biomolecular Screening facilitate assay construction, measurement instrumentation, and automation of such instrumentation. Examples of multi-well plates are provided in U.S. Pat. No. 6,426,050 and U.S. Patent Application Publication 2005/0048575.

Despite the advantages of standard multi-well plates, they are not without disadvantages. These plates work well for monitoring adherent cells, but are not ideally suited for tracking or monitoring suspension cells or cells with high motility. Tracking the same cell of interest longitudinally, especially motile cells, is a challenge. The time required to read the entire plate must be balanced by the distance traversed by a single cell in the intermediate time, and this makes it challenging for adapting the standard multi-well plate for monitoring motile or suspension single cells, longitudinally. Additionally cell-cell interactions at the single cell level are not readily tracked in standard multi-well plates.

Automated time-lapse microscopy of live cells in vitro is a well-established method for spatiotemporal recording of cells and biomolecules, and tracking multi-cellular interactions. Unfortunately, most methods assess limited numbers (10-100) of manually sampled ‘representative’ cell pairs, leading to subjective bias and therefore lack the ability to quantify the behaviors of statistically under-represented cells reliably. This is significant since many biologically significant cellular subpopulations like tumor stem cells, multi-killer immune cells and biotechnologically relevant protein secreting cells, are rare. There is a need for methods to sample cell-cell interaction events on a larger scale to investigate such cellular phenomena.

Recent advances have enabled the fabrication of large arrays of sub-nanoliter wells (or nanowells). Small groups of living cells from clinical samples, and laboratory-engineered cells can be confined to nanowells, and imaged over extended durations by multi-channel time-lapse microscopy, allowing thousands of controlled cellular events to be recorded as an array of multi-channel movies, as recently reported. The promise and challenge of nanowell arrays, is high throughput, eliminating the need for user selection of events of interest, and the ability to repeatedly follow the same cell(s) over time.

### SUMMARY OF INVENTION

In one embodiment, a multi-use combined micro and nanowell plate may provide nanowell arrays within the individual microwells of the plate. One or more microwells of the plate may provide an array of nanowells disposed at the bottom of the microwell. In other words, the multi-use combined micro and nanowell plate provides one or more microscale voids at a top region of the plate, which may be referred to as microwells. In a bottom region just below each of microwells, an array of nanoscale voids is provided, which are referred to as nanowells. The microwell and its corresponding array of nanowells are not separated from each other, which may be characterized as being in fluidic communication with each other herein. These microwells and nanowells may be any suitable shape, such as square, circular, hexagonal, rectangular, diamond, or the like. The microwells or nanowells may be frustum-shaped, cylindrical or nearly cylindrical in a shape corresponding to the abovementioned shapes.

In some cases, the combined micro and nanowell plate may be formed from a top frame with voids defining the microwells, and a bottom plate with voids defining the array of nanowells. When the top frame and the bottom plate are joined, the nanowell arrays may be aligned with the microwells to provide a combined micro/nanowell. In other embodiments, the multi-use combined micro and nanowell plate may be formed by other means, such as etching, lithography or the like.

The foregoing has outlined rather broadly various features of the present disclosure in order that the detailed description that follows may be better understood. Additional features and advantages of the disclosure will be described hereinafter.

### BRIEF DESCRIPTION OF THE DRAWINGS

For a more complete understanding of the present disclosure, and the advantages thereof, reference is now made to the following descriptions to be taken in conjunction with the accompanying drawings describing specific embodiments of the disclosure, wherein:

FIGS. 1A-1D show various views of a dataset containing fluorescently tagged human CD19-specific chimeric antigen receptor (CAR) T cells (red) and NALM-6 tumor cells (green);

FIG. 2 is an illustrative embodiment showing a cross-section view of a MiNo-well plate;

FIG. 3A is an illustrative embodiment showing a view of a top frame of a MiNo-well plate;

FIG. 3B is an illustrative embodiment showing a view of a bottom plate of a MiNo-well plate;

FIG. 3C shows an illustrative embodiment of nanowells, particularly a honeycomb pattern for nanowells;

FIG. 4 shows an illustrative embodiment of nanowells with different sizes; and

FIG. 5 shows an illustrative embodiment of nanowells with fiduciary marks.

### DETAILED DESCRIPTION

Refer now to the drawings wherein depicted elements are not necessarily shown to scale and wherein like or similar elements are designated by the same reference numeral through the several views.

Referring to the drawings in general, it will be understood that the illustrations are for the purpose of describing particular implementations of the disclosure and are not intended to be limiting thereto. While most of the terms used herein will be recognizable to those of ordinary skill in the art, it should be understood that when not explicitly defined, terms should be interpreted as adopting a meaning presently accepted by those of ordinary skill in the art.

It is to be understood that both the foregoing general description and the following detailed description are exemplary and explanatory only, and are not restrictive of the invention, as claimed. In this application, the use of the singular includes the plural, the word “a” or “an” means “at least one”, and the use of “or” means “and/or”, unless specifically stated otherwise. Furthermore, the use of the term “including”, as well as other forms, such as “includes” and “included”, is not limiting. Also, terms such as “element” or “component” encompass both elements or components comprising one unit and elements or components that comprise more than one unit unless specifically stated otherwise.

Multi-use combined micro and nanowell plates are discussed herein. These combined micro and nanowell plates may have similar specifications and standards to a typical multi-well plate, but are modified to contain nanowell arrays within the individual microwells of the plate. These combined wells, or nanowell arrays within each individual microwell, may be referred to herein as MiNo-wells or combined wells. Conforming to the standardization of multi-well plate geometry in turn allows for interfacing with other instruments like liquid handing robots, plate scanners, or the like. The ability to combine nanowells with standard multi-well plates merges the strengths of both kinds of assays: the single-cell resolution and confinement of nanowells with the parallelization available to standard multi-well plates. In some embodiments, the combined micro and nanowell plates may conform to the set standards and definitions in terms of length, width, height, well spacing and geometry set forth by the Society for Biomolecular Screening, thereby facilitating compatibility with all of the existing instrumentation that are configured to work with standard multi-well plates. These combined micro and nanowell plates may be referred to herein as combined well plates, MiNo plates, or MiNo-well plates.

A variety of multi-well plates are already commercially available for use in different contexts including cell culturing and growth, small molecule screening, or cellular assays. Conventional multi-well plates maintain a 127.76×85.47 mm footprint regardless of the number of wells. The number and spacing of the wells has been standardized around a 96 well plate which has a matrix of 8×12 wells spaced 9 mm center-to-center. Other multi-well plates based on such a pattern may increase the well density by an integer factor of the 8×12 arrangement and may adjust the size and spacing of the wells accordingly.

In embodiments of the combined well plates or MiNo-well plates discussed herein conforming to the standard footprint for multi-well plates, it shall be understood that these combined well plates may share similarities to commercially available multi-well plates. As a nonlimiting example, the combined well plate may be a rectangular plate with an array of combined wells arranged in a matrix. The matrix of combined wells may have an 8×12 arrangement or may be adjusted in a similar manner as multi-well plates by integer factor to increase well density (e.g. 8n×12n, where n is the integer factor). The matrix of microwells of the MiNo-well plates may be arranged into rows and columns in the same manner as conventional multi-well plates, such as 8 rows by 12 columns or 8n×12n. Further, the size and spacing of the microwells may similarly be adjusted as well. As a nonlimiting example, the well spacing may be 9 mm/n, where n is the integer factor.

Multi-well plates have been constructed with a variety of materials including polypropylene and have documented desirable properties like low cellular toxicity and biocompatibility, structural integrity, solvent compatibility, etc. Similarly, in embodiments of the MiNo-well plate, it may be desirable to utilize similar materials as conventional multi-well plates. It is desirable to have an optical transparent material at the bottom and walls of the plate, as this minimizes auto-fluorescence during cellular imaging. The MiNo-well plate may be constructed of an optical transparent material with low cellular toxicity and biocompatibility, structural integrity, and organic solvent compatibility. In some embodiments, the MiNo-well plate may be formed from top and bottom layers that are bonded together. In some embodiments, the top and bottom layers may comprise the same material, whereas in other embodiments, the top and bottom layers may be different materials. It should be understood that these top or bottom layers may be interchangeably referred to herein as top or bottom layers, plates, or frames.

It shall be understood that the MiNo-well plates discussed herein provide combined wells that provide both microwells and nanowells. For the purposes of brevity, these microwells or nanowells may collectively be referred to herein as ‘combined wells’ or ‘wells’, and it shall be understood that any discussion of the features provided by such ‘combined wells’ or ‘wells’ may apply to both the microwells and nanowells. Each combined well is formed from a combination of a microwell that is a cylindrical/nearly-cylindrical void and an array of nanowells that are also cylindrical/nearly-cylindrical voids. Further, the microwell and array of nanowells are in fluidic communication to provide the combined well. Individual combined wells are separated from each other by the plate or frame material and can be characterized as being fluidically isolated from each other. Each combined well in the MiNo-well plate may have opaque sides and a transparent or substantially transparent bottom suitable for spectroscopic measurements of biological and biochemical samples. The material(s) comprising the well walls and bottoms of the wells, such a cyclo-olefin polymer or copolymer, have sufficient thermal, mechanical, and chemical resistance to enable storage of chemical samples and biological cells. It is noted that the top or bottom plate material may be referred to herein as cyclo-olefin polymer, which shall be construed to include cyclo-olefin olefin polymer (COP) and cyclo-olefin copolymer (COC), unless expressly distinguished in an example or otherwise.

In some embodiments, the combined wells of the MiNo-well plate are arrayed in a planar pattern to provide high-density, low-volume formats for automated liquid chemical handling and assay systems capable of manipulating and assaying in parallel. The side and bottom materials of the wells may exhibit low fluorescence when illuminated with screening wavelengths, e.g., in the ultraviolet or visible, and have high transmittance to these wavelengths for the purposes of fluorescence excitation and the reading of subsequent fluorescence emission through the well bottom. Wavelengths between approximately 200 nm and 800 nm may be used for screening using a plate in some embodiments.

The heat resistance of the top or bottom plate material provides for thermal sterilization so that cells can be maintained without contamination. The top or bottom plate material may be chemically resistant to enables concentrates of chemical compounds in various solvents to be stored without contamination. In some embodiments, the plate may incorporates an arrangement of wells not used for assay or chemical storage, but which contain an assay liquid or storage solvent to mitigate evaporation of liquid in the wells used for chemical storage or assay. In addition, the plate may include additional useful features, such as indentations for the accommodation of lids to maintain a closed environment surrounding the liquid contents of the wells, or markings to enable optically guided automated alignment of the plate with instrumentation.

MiNo-well plates may be used for spectrometric assays, as platforms used for storage of chemical compounds and in methods for using such platforms. The MiNo-well platforms are useful for the storage of small liquid volumes of chemical compounds at high concentrations. The MiNo-well platforms can be used in automated and integrated systems in which small volumes of stored chemical compounds are transferred from one MiNo-well platform used for storage purposes to another MiNo-well platform used to construct assays for chemical or biological activities of those same compounds, particularly automated screening of low-volume samples for new medicines, agrochemicals, food additives, cosmetics, or the like.

The MiNo-well plate may also be useful for chemical storage, as a container for miniaturized fluorescence assays, and other aspects of chemical and biological screening.

Nonlimiting examples of materials that meet the desired properties for MiNo-well plate may include cyclo-olefin copolymer (COC), Cyclo-olefin polymer (COP), copolymer (COC), glass, or the like.

In some embodiments, the MiNo-well plate may be formed by bonding a top frame to a bottom plate. The top frame may be patterned with voids that provide the desired microwells, and the bottom plate may be patterned with voids that provide the desired nanowells. A suitable adhesive may be used to bond a top frame with microwells to the bottom plate containing nanowells. The adhesive may be inert to solvents (e.g. DMSO, water, acetonitrile, etc.) that are commonly used in bimolecular or high-throughput screening, biocompatible, and preferably, FDA approved for use in a medical/clinical setting. In other embodiments, thermal bonding may be utilized to bond the top frame to the bottom plate, thereby ensuring an adhesive free seal.

A common issue encountered with standard multi-well plates is evaporation. In order to address evaporation problems, the MiNo-well plates may be fabricated to provide either an outer channel like reservoir containing sterile liquid or a sacrificial outer layer of wells close to the edges.

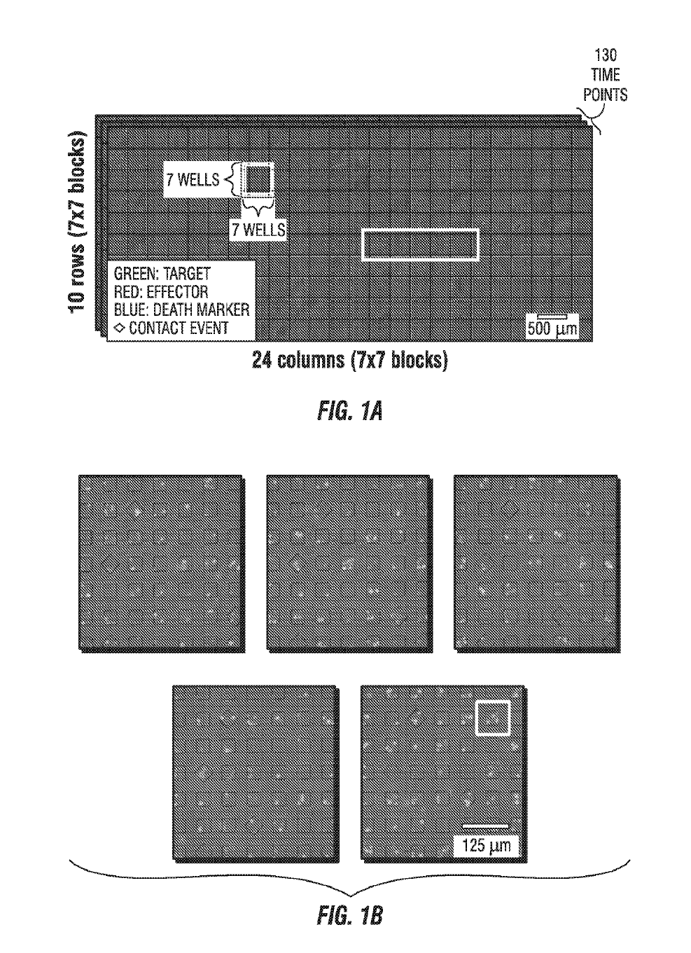

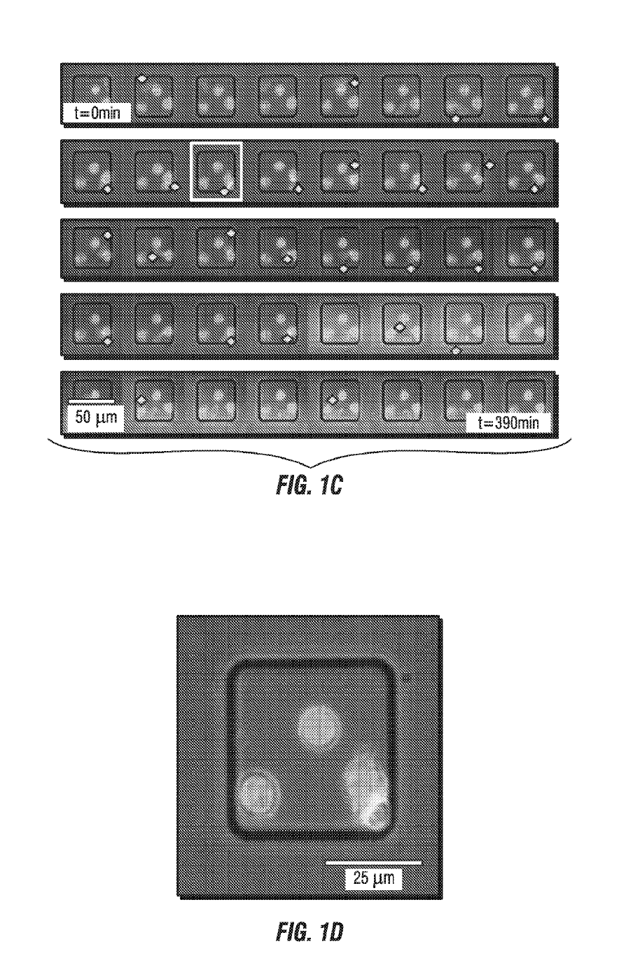

FIG. 1A illustrates a dataset comprising more than 11,000 nanowells (10 row×24 columns of 7×7 well blocks) containing fluorescently tagged human CD19-specific chimeric antigen receptor (CAR) T cells (red) and NALM-6 tumor cells (green) that were imaged by time-lapse microscopy over 80 time points at 5-min intervals to yield an array of 4-channel movies, one per nanowell. FIG. 1B illustrates an enlarged view of five 7×7 blocks from FIG. 1A. FIG. 1C illustrates a time lapse of a row from the 7×7 blocks, and FIG. 1D illustrates and enlarged view of one of the wells from FIG. 1C.

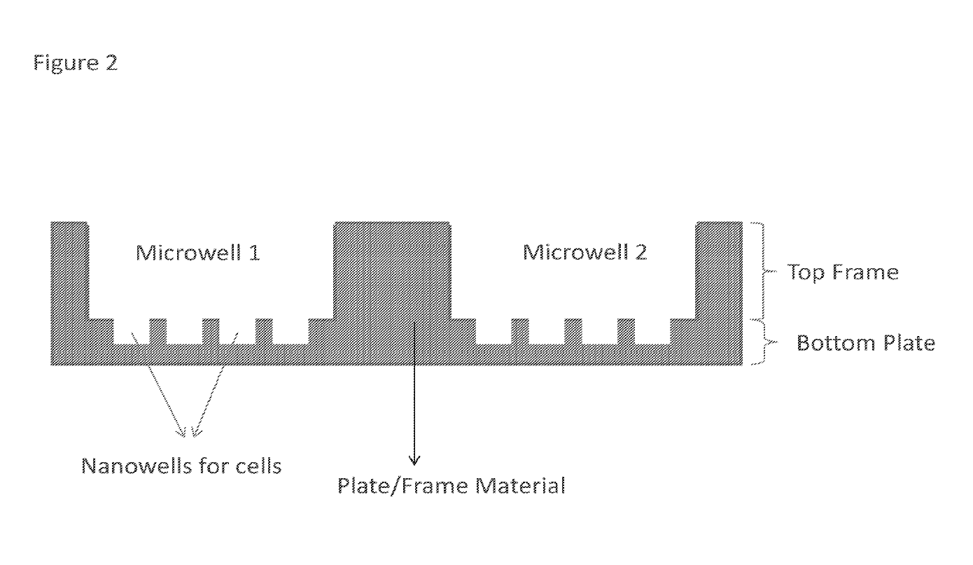

FIG. 2 is an illustrative embodiment showing an enlarge cross-section view of a portion of a combined well plate or MiNo-well plate 100. The MiNo-well plate 100 is composed of a top frame 10 and bottom plate 20. The top frame 10 and bottom plate 20 may each be formed from a sheet or layer of material (e.g. cyclo-olefin polymer) of suitable dimensions. For example, the MiNo-well plate may have any suitable dimension that conform those specified by the Society for Biomolecular Screening (e.g. 127.76×85.48 mm). The top frame 10 of the MiNo-well plate may provide a matrix of at least 96 microwells 30, and the bottom plate 20 provides nanowell 40 arrays within the individual microwells when bonded to the top frame. Each set of nanowell 40 arrays is aligned with an individual microwell 30 to form the combined well. The structure of each well in the matrix can be seen from the two wells shown in FIG. 2. Each well in the matrix is a combined well or MiNo-well that provides nanowell 40 arrays within the individual microwells 30 or nanowells that are in fluidic communication with the individual microwells. The matrix or array of MiNo-wells provides a first set of one or more voids in a top frame 10 of the plate material, which correspond to microwells 30. The matrix or array or microwells 30 may be arranged in an 8×12 or 8n×12n (where n is an integer) manner of aligned rows and columns. In other embodiments, the microwells 30 may be arranged in a honeycomb arrangement. The first set of voids may have dimensions corresponding to the shape or dimensions of any suitable microwell 30. In some embodiments, the shape of the first set of voids defining the microwells 30 may be selected from squares, circles, hexagons, rectangles, diamonds, or the like. In some embodiments, a microwell 30 may have a volume in the μL scale, such as equal to or between approximately 1-500 μL. Further, the dimension of the microwells 30 may be mm-sized, e.g. height, length, width, diameter, or the like depending on the shape being used. The first set of voids 30 span the entire thickness from top to bottom of the top frame 10 so that fluid communication to the nanowells 40 of the bottom plate 20 is achieved when the top frame and bottom plate are placed together. In other words, fluidic communication refers to the array of nanowells 40 being combined with the microwell 30 without a fluid barrier separating the two wells. It should also be noted that the material of the top frame 10 in turn defines the individual combined wells with boundaries such that there is no fluid exchange between separate combined wells. In other words, the multi-use combined micro and nanowell plate 100 provides one or more microscale voids in a top layer 10 of the plate, which may be referred to as microwells 30. In a bottom layer 20 just below each of microwells 30, an array of nanoliter to picoliter voids are provided, which are referred to as nanowells 40. These nanowells or first voids 40 span less than an entire thickness of the bottom layer 20 or do not extend all the way through the bottom layer. In some embodiments, the microwells 30 or nanowells 40 may be frustum-shaped, which may aid manufacturing. Further, the nanowells 40 may be selected from any of the abovementioned shapes discussed above for microwells 30. In some embodiments, the microwells 30 or nanowells 40 may be cylindrical or nearly cylindrical in a shape corresponding to the abovementioned shapes. In some embodiments, a nanowell 40 may have a volume in the nL to pL scale, such as equal to or between approximately 1 pL-10 nL. Further, the dimension of the nanowells 30 may be μm-sized, e.g. height, length, width, diameter, or the like depending on the shape being used. The microwells 30 may extend all the way through the top layer 10. Thus, the microwells are not from separated corresponding array of nanowells and form a combined well (or MiNo-well) with the nanowells. This arrangement of the microwell and nanowell array that provides a combined well may be characterized herein as being in fluidic communication with each other. For example, from a cross-section or side view, an individual MiNo-well can be visualized as an array of nanoscale voids that are frustum- or cylindrically-shaped (e.g. squares, circles, hexagons, rectangles, diamonds, or the like) that are positioned just below a microscale void is also frustum- or cylindrically-shaped. It shall be apparent that fluid filling the microwell 30 and corresponding array of nanowells 40 (or the combined well) is free to mix or communicate any other fluid present in the combined well.

The top frame can be visualized as a plate that is similar to a conventional multi-well plate, except the voids providing the microwells span the entire thickness from top to bottom. As a nonlimiting example of top frame, an array of circular voids (or optionally other shapes) or microwells may be provided in the top frame. The microwells may be arranged in a rectangular grid of aligned rows and columns, honeycomb, or any other suitable pattern. The microwells are formed in a planar slab of material that provides rigid support for the microwell walls. Each microwell is a void that completely penetrates from top to bottom through the solid material used, such as a symmetric circle. In some embodiments, the microwells may have the shape of the frustum of a base shape. As a result, the microwell wall has a draft angle with respect to the longitudinal axis of the well. For example, when the microwell is circular in shape, the diameter at the bottom of the microwell is smaller than the diameter at the top.

As discussed previously, an 8×12 well array for a conventional, standard 96-well plate has 9 mm center-to-center spacing between the microwells. Further, the 8×12 well array can be expanded by an integer factor and the center-to-center spacing may be reduced so that the well plate provides more wells. Similarly, a MiNo-well plate may conform to the arrangement of standard multi-well pates as well, or more particularly, the top frame for the MiNo-well plates may provide an 8×12 microwell array that can also be expanded by an integer factor n. Further, for the MiNo-well plate, the top frame spacing between the center of adjacent microwells may be an integer factor of the desired 9 mm (or 9 mm/n, where n is the integer factor) spacing for standard multi-well plates. This is to facilitate ready use of the plate by liquid-handling and fluorescence measurement instrumentation or other equipment manufactured in accordance with the standard for well plates provided by the Society for Biomolecular Screening. For example, for a top frame with an array of at least 48×72 sample microwells (8n×12n, where n=6), the microwell center-to-well center spacing may be no greater than 1.5 mm to accommodate a total of at least 3456 sample microwells. In some embodiments, the thickness of the top frame may be 15 mm or less. In some embodiments, diameter or length of the microwells of the top frame may be 1.5 mm or less. In some embodiments, the total volume provided by an individual microwell may be 10 μL or less.

The thickness of the MiNo-well plate may be selected to meet the desired requirements for the volume of each well to accommodate the liquid sample (e.g. total volume of 1 mL or less) and the rigidity desired to maintain a desired flatness of the top and bottom surfaces and to avoid deformation of the well walls. Thus, it shall be understood that the dimensions of the top frame, bottom plate, microwells, and nanowells provided herein are merely examples any may be adjusted as needed.

In contrast other multi-well plates, each combined well may also provide one or more second void(s) in a bottom plate 20. The bottom plate 20 may provide the one or more second voids that define a plurality of nanowell 40 arrays for each microwell 30 of the top frame 10. Unlike the first voids or microwells 30 of the top frame 10, the one or more second void(s) or nanowell 40 arrays do not pass through the entire thickness of the bottom plate 20. The one or more second void(s) may have dimensions corresponding to the shape or dimensions of any suitable nanowell. In some embodiments, the shape of the one or more second void(s) defining the nanowells may be selected from squares, circles, hexagons, rectangles, diamonds, or the like. In some embodiments, the one or more second void(s) may be cylindrical and/or frustum shaped. The bottom plate may be bonded or coupled to the top frame to form the MiNo-well plate, and each of the microwells of the top frame may be aligned with an array of nanowells provided by the bottom plate. In other words, when the top frame and bottom plate are mated together properly, the one or more nanowells provided the bottom plate line up with the microwells to form nanowell arrays within the individual microwells as shown in FIG. 2.

As with the top frame, the material of the bottom plate may satisfy various requirements discussed previously, including low cellular toxicity and biocompatibility, structural integrity, solvent compatibility, high optical transmittance (e.g. 200-800 nm light) and low auto fluorescence. Examples of these materials include high quality glass or cyclo-olefin polymer. The advantages of cyclo-olefin polymer (COP) or cyclo-olefin polymer are listed in detailed in U.S. Patent Appl. Pub. 2005/0048575 and additional examples of platforms, multi-well plates and lids are described in U.S. Pat. No. 6,426,050, which are incorporated by reference herein in their entirety.

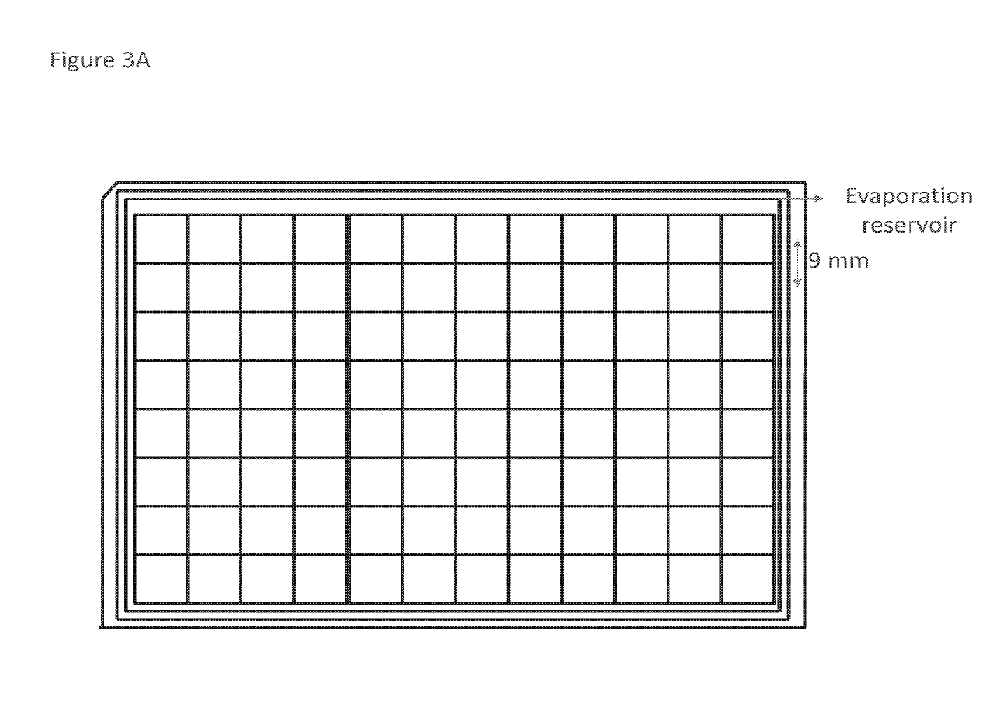

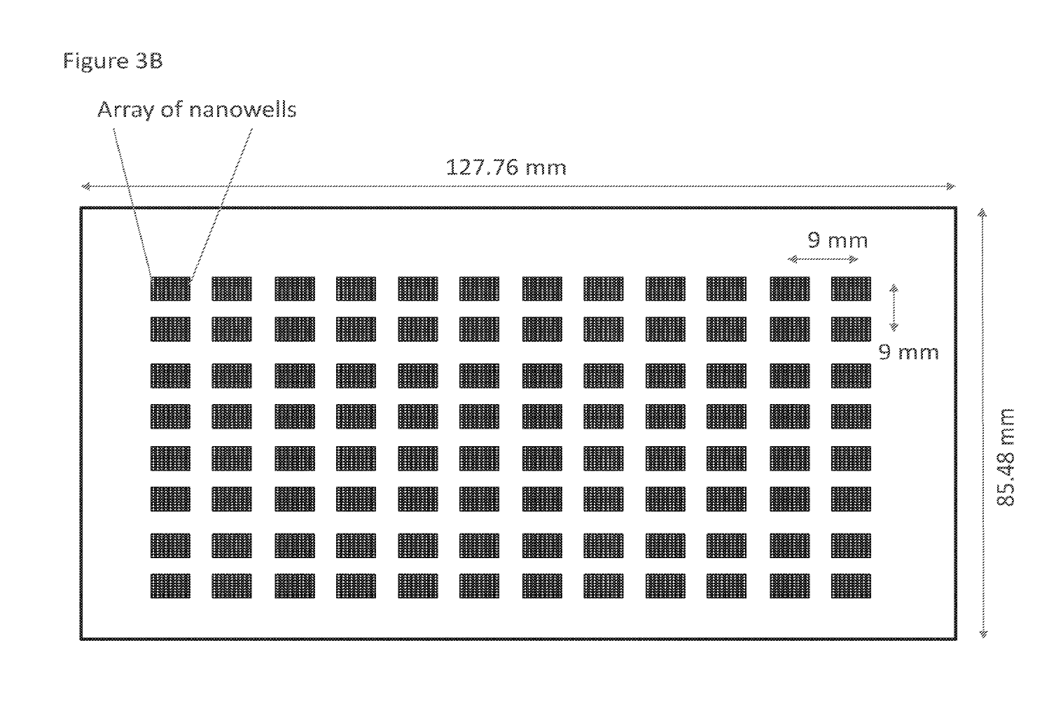

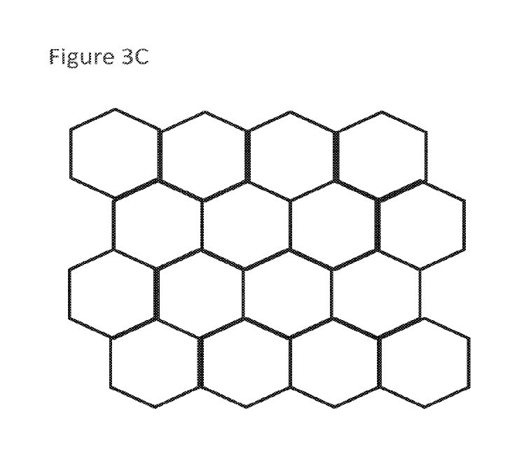

FIG. 3A is an illustrative embodiment showing a view of a top frame of a MiNo-well plate. In some embodiments, the top frame may be fabricated to provide an outer channel 50, such as an evaporation reservoir (trough/moat), around the perimeter of the plate that surrounds the array of combined wells. In other some embodiments, a sacrificial outer layer of microwells close to the edges may be provided to address evaporation issues.

FIG. 3B is an illustrative embodiment showing a view of a bottom plate of a MiNo-well plate. In the nonlimiting example of the bottom plate shown, the bottom plate may provide multiple arrays of nanowells 60 that will align with the microwells of the top plate. Like the top plate, the bottom plate may be a 137.76 mm×85.48 mm plate. Further, 9 mm spacing may be provided center-to-center between each nanowell array. The bottom plate may also be made of a material that conforms to all the requirements including low cellular toxicity and biocompatibility, structural integrity, solvent compatibility, high optical transmittance (200-800 nm light) and low auto fluorescence. The bottom plate contains a plurality of arrays 60 of nanowells spaced to match the standard size of the microwell plate and align with the microwells of the top plate. The nanowells may have dimensions equal to or between 3-500 microns, such as the diameter, length or width depending on the shape selected. The depth of the nanowells can be equal to or between 20-500 microns. The thickness of the bottom plate is designed to 200 microns or less, promoting high resolution optical imaging. It should be noted that the array of nanowells may be patterned in any manner desired as they do not require a standardized pattern. Thus, any suitable pattern for the arrangement of the array of nanowells is suitable.

The microwells or nanowells may be fabricated onto the bottom plate or in the top frame by laser cutting, micromachining, embossing or imprinting or any of the standard methods used for creating micro or nanoscale sized structures known by those skilled in the art.

The top frame (e.g. FIG. 3A) and the bottom plate (e.g. FIG. 3B) may be bonded together to for the MiNo-well plate using adhesives that are inert to solvents (e.g. DMSO/water/acetonitrile) that are commonly used in high-throughput screening, and biocompatible and preferably FDA approved for use in a medical/clinical setting. In other embodiments, thermal bonding may be utilized to provide an adhesive free seal.

The assembled plate obtained by bonding the top frame to the bottom plate may further provide evaporation control elements. In some embodiments, an outer channel, such as a reservoir, trough, or moat may be provided for evaporation control. As a nonlimiting example, the top frame may provide an evaporation reservoir or channel. In other embodiments, a sacrificial outer layer of wells close to the edges may be provided for evaporation control. Center-to-center well spacing in a standard 96-well plate format is 9 mm. The MiNo-well plate may utilize 9 mm spacing between combined wells or an integer factor of the 9 mm spacing (or 9 mm/n, where n is the integer factor).

While the embodiments discussed above form the MiNo-well plates from joining a top frame and bottom plate, in other embodiments, it may be possible to form the MiNo-well plates utilizing known methods for fabricating voids in plates of materials, such as by etching, lithography, or the like. In some embodiments, the MiNo-well plate may be formed from a single slab of material(s).

The assembled MiNo-well plate may include an optional lid constructed out of glass, cyclo-olefin polymer, or any suitable material. In some embodiments, the MiNo-well plate is further oxidized by oxygen or air plasma either immediately prior to use, or pre-oxidized and stored under vacuum.

FIG. 3C shows an illustrative embodiment of nanowells, particularly a honeycomb pattern for nanowells. In some embodiments, the nanowells are arranged in a honeycomb pattern. In some embodiments, the nanowells are arranged as an array of squares. In some embodiments, the nanowells are arranged as arrays of circles.

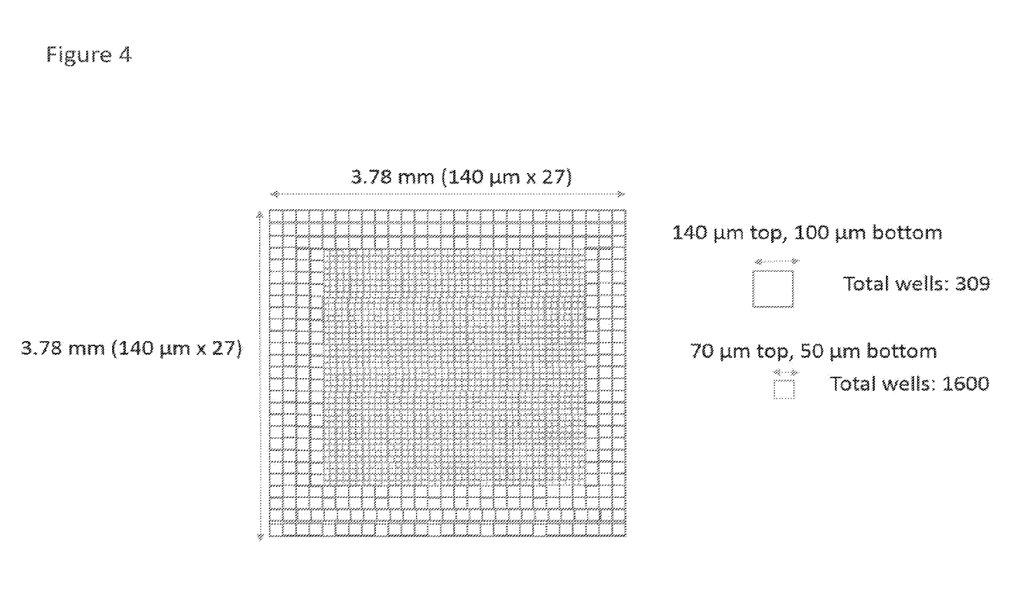

FIG. 4 shows an illustrative embodiment of nanowells with different sizes. In some embodiments, an array of nanowells within the same microwell may comprise nanowells of different sizes. As a nonlimiting example, the nanowells on the outer perimeter or outer nanowells 70 of the nanowell array may be larger than the interior nanowells 80. In the nonlimiting example, the outer nanowells 70 are 140 μm squares with a 100 μm depth, and the interior nanowells are 70 μm squares with a 50 μm depth. Further, the total dimensions of the array are 3.78 mm×3.78 mm.

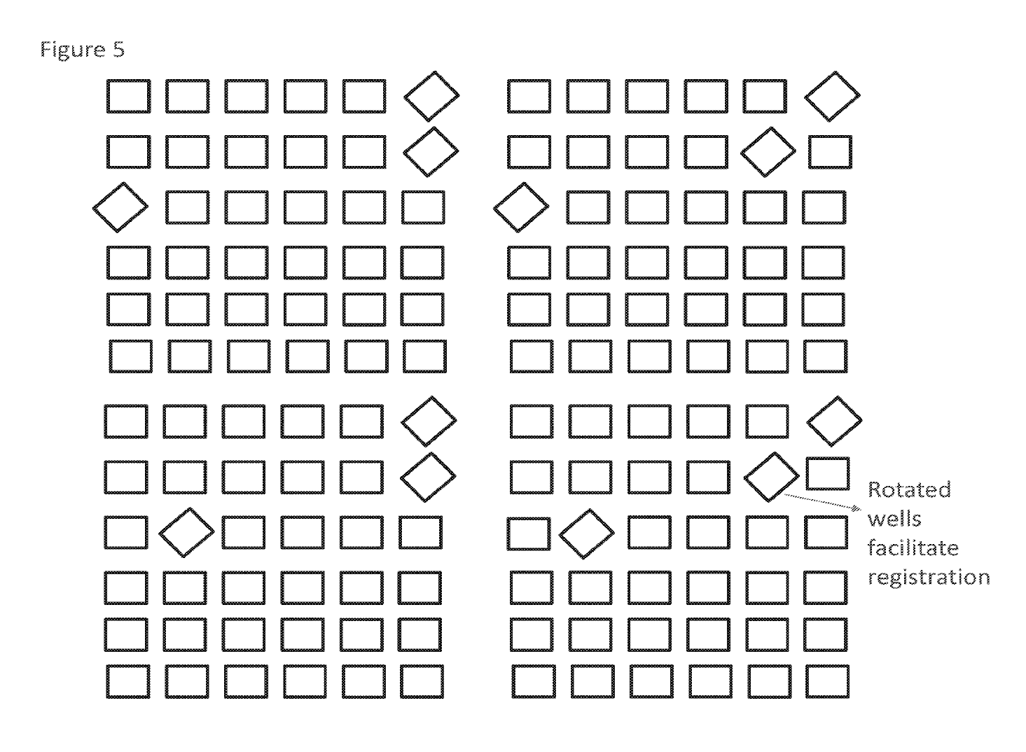

FIG. 5 shows an illustrative embodiment of nanowells with fiduciary marks. In some embodiments, nanowells may contain fiduciary marks (e.g. roman numerals) to facilitate registration. In some embodiments, one or more nanowells can be arranged a different geometry (e.g. nanowell rotated relative to or in comparison to other nanowells) to facilitate registration. As a nonlimiting example, rectangular-shaped nanowells are arranged into aligned rows and columns. However, some nanowells 90 may have an alignment that is rotated relative to the other nanowells. In some embodiments, the nanowells are arranged as “blocks” or sets of nanowells that are designed to fit in the single field of view of a camera. In this arrangement, the center to center spacing between each block also matches the field of view of the camera.

In some embodiments, the indexing/registration of nanowells may be used to retrieve individual cell(s) from one or more nanowells from within a microwell. The cell(s) can be further subject to transcriptional or genomic profiling. Alternately, the cell(s) can be subject to proliferation subsequent to retrieval.

In some embodiments, cells are first seeded into the nanowells and sealed using a porous membrane with pore diameters of equal to or between 1-200 kDa. Cells are seeded on top of the membrane, and thus, the cells in the nanowells and the cells on the membrane can exchange soluble chemicals/proteins with each other, where the size of these molecules being determined by the size of the pore on the membrane.

In some embodiments cells are first seeded into the nanowells and sealed using a porous membrane, like Matrigel®. The ability of cells from the nanowells to migrate across the Matrigel can be quantified as a measure of the invasiveness.

### EXPERIMENTAL EXAMPLE

The following examples are included to demonstrate particular aspects of the present disclosure. It should be appreciated by those of ordinary skill in the art that the methods described in the examples that follow merely represent illustrative embodiments of the disclosure. Those of ordinary skill in the art should, in light of the present disclosure, appreciate that many changes can be made in the specific embodiments described and still obtain a like or similar result without departing from the spirit and scope of the present disclosure.

### Example 1

Bacterial antibiotic screening: A suspension of methicillin resistant S. aureus is seeded onto each MiNo-well of the MiNo-well plate. The MiNo-well plate has been fabricated in COP to contain 20,000 circular nanowells that are 5 micron in diameter within each microwell. Each microwell of the 384 microwell MiNo-well plate is treated with a different combination of small molecule antibiotics. The kinetics of the antibiotic response, as well as phenotypes of single bacteria, is recorded using an imaging multi-well plate reader. Antibiotic combinations that induce death, the fastest or that induce death in the highest frequency of cells are prioritized.

### Example 2

Tumor Toxicity Screens:

Adherent MDA-MB-231 breast cancer cells are seeded onto each microwell of the MiNo-well plate. The MiNo-well plate was fabricated from COP to contain 2,000 square nanowells that are 50 micron in edge length, within each microwell. Each microwell of the 96 microwell MiNo-well plate is treated with a different small molecule drug. Dose responses curves and phenotypic changes in the tumor cells are recorded using an imaging multi-well plate reader. The screen is used to prioritize cytotoxic drugs. Alternately, known chemotherapeutic drugs are added to tumor cells and the surviving cells are retrieved, subjected to expansion and transcriptional/genomic profiling.

### Example 3

Car T Cells:

Chimeric antigen receptor T cells and tumor cells are seeded onto each microwell of the MiNo-well plate. The MiNo-well plate has been fabricated in COP to contain 2,000 square nanowells that are 50 micron in edge length within each microwell. Each microwell of the 96 microwell MiNo-well plate receives T cells that contain a different variation of the CAR molecule (antigen target, endodomains, etc.). Cell-cell interactions (FIG. 1) are tracked within the nanowells and subsequent to image segmentation and tracking. CARs are prioritized based on their ability to (a) participate in serial killing, (b) display high motility and (c) avoid apoptosis. Additionally, serial killer CAR T cells can be retrieved for transcriptional profiling using RNA-seq.

### Example 4

Stem Cell Differentiation:

Stem cells present great potential as therapeutics in a variety of diseases including Parkinson's disease. The self-renewal and differentiation of these stem cells involves a cascade of events triggered by spatiotemporal cues that result in phenotypic changes. Small molecules can function as tools to elucidate the mechanisms of differentiation and also functions as agents promoting programmable differentiation. Human pluripotent stem cells (hPSCs) are seeded onto each microwell of the MiNo-well plate. The MiNo-well plate has been fabricated in COP to contain 2,000 square nanowells that are 50 micron long within each microwell. Each microwell of the 96 microwell MiNo-well plate is treated with a different small molecule and the kinetics and phenotype of differentiation are monitored quantitatively to enable identification of lead compounds.

### Example 5

Endothelial Cell Mesenchymal Stem Cell Interactions:

Within the field of bone tissue engineering, human mesenchymal stem cells (hMSCs) are colonized onto an implantation scaffold. In order to overcome the limitation of the lack of blood vessels, vascularization of the scaffold is facilitated by the addition of endothelial cells (EC). This process aims to take advantage of the reciprocal cell-cell interactions required during stem cell differentiation. hMSC and ECare seeded onto each microwell of the MiNo-well plate. The MiNo-well plate has been fabricated in COP to contain 2,000 square nanowells that are 50 micron long within each microwell. Each microwell of the 96 microwell MiNo plate is treated with a different cocktail of growth factors and the interactions between ECs and hMSCs are studied at the single cell level. Growth factors that induce osteogenic, chondrogenic, and adipogenic differentiation can be separately identified and prioritized.

### Example 6

Miniaturized Clonogenic Assay (Colony Forming Assay):

Tumor cells or stem cells are seeded onto each microwell of the MiNo-well plate. The MiNo-well plate has been fabricated in COP to contain 200 square nanowells that are 500 micron long within each microwell. Each microwell of the 96 microwell MiNo-well plate receives tumor cells or stem cells at different concentration (there can be several dilutions, in a range determined empirically or based on predicted growth plate efficiencies after control condition of after treatment condition) and cell are let to settle for 5 minutes or to attach for 2 h. If the cell are non-adherent, they can be deposited in a 0.3% agar medium, or if the cells are adherent, directly in liquid medium. The medium can be standard culture medium, or might need to be a pre-conditioned medium. Cells are then submitted to treatment (e.g. irradiation or chemical compound), or the treatment can also be administered before plating the cells onto the MiNo plate. The plate is then incubated for a time needed to generate 3-6 cycles of mitosis. Then cells can be stained with fluorescent labelled antibodies specific to lineage or cancer marker and then imaged using fluorescent microscopy, or cells can be stained using a fixation-staining solution of 6.0% glutaraldehyde and 0.5% crystal violet. Colonies are counted, identified if needed, and data are analyzed.

Embodiments described herein are included to demonstrate particular aspects of the present disclosure. It should be appreciated by those of skill in the art that the embodiments described herein merely represent exemplary embodiments of the disclosure. Those of ordinary skill in the art should, in light of the present disclosure, appreciate that many changes can be made in the specific embodiments described and still obtain a like or similar result without departing from the spirit and scope of the present disclosure. From the foregoing description, one of ordinary skill in the art can easily ascertain the essential characteristics of this disclosure, and without departing from the spirit and scope thereof, can make various changes and modifications to adapt the disclosure to various usages and conditions. The embodiments described hereinabove are meant to be illustrative only and should not be taken as limiting of the scope of the disclosure.

What is claimed is:

1. A multi-well plate providing combined microwell and nanowells, the plate comprising:
a rectangular plate providing an array of combined wells, wherein each of the array of combined wells provides
a bottom array of nanowells, wherein each of the nanowells of the bottom array is a first void with a nanoliter to picoliter scale volume, and
a top microwell in fluidic communication with the bottom array, wherein the microwell is a second void with a microliter-scale volume, and the microwell is aligned with said bottom array of nanowells.

2. The plate of claim 1, wherein the array of combined wells are arranged in an 8n×12n pattern of aligned rows and columns where n is an integer.

3. The plate of claim 1, wherein the rectangular plate comprises a top frame, the top frame provides the second voids for the top microwells, and the second voids span an entire thickness of the top frame.

4. The plate of claim 3, wherein the rectangular plate comprises a bottom plate, the bottom plate provides the first voids for the bottom array of the nanowells, and the first voids span less than an entire thickness of the bottom plate.

5. The plate of claim 1, wherein the plate provides an evaporation reservoir surrounding the array of combined wells.

6. The plate of claim 1, wherein the microwell is square, circular, hexagonal, rectangular, or diamond.

7. The plate of claim 6, wherein the microwell is cylindrical or frustum-shaped.

8. The plate of claim 1, wherein the nanowells are square, circular, hexagonal, rectangular, or diamond.

9. The plate of claim 8, wherein the nanowell are cylindrical or frustum-shaped.

10. The plate of claim 1, wherein the nanowells are arranged in a honeycomb pattern.

11. The plate of claim 1, wherein the bottom array of the nanowells provides wells of different sizes.

12. The plate of claim 1, wherein at least one nanowell from the bottom array is rotated relative to other nanowells from the bottom array.

13. A method for forming a multi-well plate providing combined microwell and nanowells, the method comprising:
forming a top frame with an array of second voids, wherein the second voids span an entire thickness of the top frame, and the second voids are microwells with a microliter-scale volume;
forming a bottom plate with an array of first voids, wherein the first voids span less than an entire thickness of the bottom plate, and the first voids are nanowells with a nanoliter to picoliter scale volume; and
mating the top frame and bottom plate, wherein the top frame and bottom plate are mated so that each array of first voids are aligned with one of the array of second voids to provide an array of combined wells.

14. The method of claim 13, wherein the mating step is performed by bonding the top frame to the bottom plate.

15. The method of claim 14, wherein the bonding is performed utilizing thermal bonding or utilizing an adhesive inert to solvents for bimolecular screening.

16. The method of claim 13, wherein the array of combined wells are arranged in an 8n×12n pattern of aligned rows and columns where n is an integer.

17. The method of claim 13, wherein the top frame provides an evaporation reservoir surrounding the array of combined wells.

18. The method of claim 13, wherein the microwells or nanowells are square, circular, hexagonal, rectangular, or diamond.

19. The method of claim 18, wherein the microwells or nanowells are cylindrical or frustum-shaped.

20. The method of claim 13, wherein the nanowells are arranged in a honeycomb pattern.

21. The method of claim 13, wherein the nanowells provides wells of different sizes.

22. The method of claim 13, wherein at least one nanowell is rotated relative to other nanowells.
